(19) United States
(12) Patent Application Publication
(10) Pub. No.: US 2022/0143837 A1
(43) Pub. Date: May 12, 2022

(54) Robot-Assisted Grinding Device having an Integrated Maintenance Unit

(71) Applicant: FerRobotics Compliant Robot Technology GmbH, Linz (AT)

(72) Inventor: Ronald Naderer, Linz (AT)

(21) Appl. No.: 17/425,677

(22) PCT Filed: Jan. 21, 2020
(86) PCT No.: PCT/EP2020/051446

§ 371 Date: Jan. 17, 2022

(30) Foreign Application Priority Data
Jan. 23, 2019 (DE) 10 2019 101 580.4

(51) Int. Cl. B25J 11/00; B25J 9/12; B24B 51/00; B24B 53/00

(52) U.S. Cl. CPC B25J 11/0065; B24B 53/00; B24B 51/00; B25J 9/123

(57) ABSTRACT

An apparatus for the robot-assisted machining of surfaces is described. In accordance with one embodiment, the device comprises the following: a support which can be mounted on a manipulator, a machining device with a tool (e.g. a grinding disc) and a linear actuator for adjusting the relative position of a tool in relation to the support. The apparatus further has a maintenance unit comprising a swiveling bracket. The bracket is swivel-mounted on the support such that, by swiveling the bracket, the maintenance unit can be positioned at least partially before the tool.

### TECHNICAL FIELD

The present invention relates to the field of robotics and, in particular, to an apparatus for the robot-supported machining of work piece surfaces.

### BACKGROUND

During the robot-supported machining of surfaces, a machine tool such as, e.g., a grinding or polishing machine (e.g. an electrically driven grinding machine with a rotating grinding disk as grinding tool) is guided by a manipulator, for example, by an industrial robot. During this process, the machine tool may be coupled in various manners to the so-called TCP (tool center point). In general, the manipulator is capable of adjusting the machine to virtually any position and orientation and can move the machine tool along a trajectory, e.g. parallel to the surface of the work piece. Industrial robots are generally position-controlled, which makes it possible for the TCP to be moved precisely along the desired trajectory.

In many applications, in order to obtain good results from robot-supported grinding, the machining force (grinding force) must be regulated, which is not often easy to achieve with sufficient accuracy when conventional industrial robots are employed. The large, heavy arm segments of industrial robots have an amount of mass inertia that is too high for a controller (closed-loop controller) to be able to react quickly enough to fluctuations in the machining force. To solve this problem, a linear actuator, smaller (and lighter) than the respective industrial robot, can be arranged between the TCP of the manipulator and the machine tool which couples the TCP of the manipulator to the machine tool. In this case, during the machining of the work piece surface, the linear actuator only controls the machining force (that is, the pressing force between tool and work piece), while the manipulator moves the machine tool, together with the linear actuator, along the desired trajectory and controls their position. By controlling the force, the linear actuator can compensate (to a certain extent) for inaccuracies in the position and form of the machined work piece, as well as for inaccuracies in the trajectory of the manipulator.

During grinding processes in particular, grinding dust may become adhered to the grinding disc, reducing the grinding efficiency of the grinding disc. This problem can be remedied through a maintenance procedure, during which the grinding disc is either replaced or “refreshed”. The grinding discs of robot-supported grinding devices can be replaced in known stationary changing stations (see, e.g. WO 2017/174512 A1). In order to change a grinding disc, the robot must interrupt the program currently being executed, it must move the grinding device to the changing station, carry out the changing of the disc, and move the grinding machine back to a position at the work piece from where the grinding procedure can be continued. For example, when small sheets of grinding paper are used such as those used, e.g. for so-called “spot repairs”, the grinding discs have to be replaced comparatively often, which has negative consequences for the machining time per work piece.

The inventors have set themselves the goal of developing an improved apparatus for robot-frame surface machining, as well as a corresponding method in which, in particular, the maintenance of the employed tools (e.g. grinding discs) should be rendered less time-consuming.

### SUMMARY

The aforementioned goal is achieved by the apparatus in accordance with claim 1, as well as by the method in accordance with claim 9. Various embodiments and further developments form the subject matter of the dependent claims.

In the following, an apparatus for the robot-supported machining of surfaces will be described. In accordance with one embodiment the apparatus comprises the following: a frame which can be mounted onto a manipulator, a machining device with a tool (e.g. a grinding disc, drivable by a motor of the machining device) and a linear actuator for adjusting the relative position of the tool in relation to the frame. The apparatus further comprises a maintenance unit with a swiveling bracket. The bracket is mounted on the frame such that it can be swiveled, by means of which the maintenance unit can be swiveled to position it at least partially in front of the work piece.

Further, a method for a robot-supported machining apparatus with integrated maintenance unit will be described. In accordance with one embodiment, the method comprises positioning the maintenance unit, which is swivel-mounted on a frame, into a position in which the maintenance unit is positioned before a tool of a machining device. The tool, in this case, is coupled to the frame via a linear actuator and the frame is mounted on a manipulator. The method further comprises pressing the tool against a component of the maintenance unit with the aid of the linear actuator. In accordance with one embodiment, the component of the maintenance unit against which the tool is pressed may comprise a brush. In another embodiment this component is the bearing surface of a removal unit for removing the tool from the machining device.

A further embodiment refers to a method for the automated changing of grinding discs of a grinding machine. In this embodiment a maintenance unit which can be swiveled relative to the grinding machine is brought from a first position into a second position by swiveling the maintenance unit. In this second position the maintenance unit is positioned before a grinding disc attached to a tool plate of the grinding machine. The method further comprises pressing the grinding disc which is attached to the tool plate against a bearing surface of a removal unit of the maintenance unit. Following this, the maintenance unit is swiveled further until an edge of a separation plate of the removal unit is inserted between the tool plate and the grinding disc, thereby detaching the latter from the tool plate.

A further embodiment refers to a method through which a maintenance unit with a nozzle and which can be swiveled relative to a polishing machine is swiveled into a maintenance position in which the nozzle is aimed at a polishing tool of the polishing machine. The method further comprises applying a polishing agent onto the polishing tool by spraying the polishing agent onto the polishing tool with the aid of the nozzle and swiveling the maintenance unit into a folded up position in which it does not impede the subsequent polishing process.

### BRIEF DESCRIPTION OF THE DRAWINGS

The invention will now be described with reference to the examples illustrated in the figures. The illustrations are not necessarily true to scale and the invention is not limited to the aspects illustrated here. Instead importance is given to illustrating the underlying principles of the invention. Regarding the figures:

FIG. 1 illustrates an example of a robot-supported grinding apparatus.

FIG. 2 illustrates an example of a grinding apparatus which is suitable for robot-supported grinding and which has an integrated maintenance unit for cleaning the grinding tool.

FIGS. 3 and 4 illustrate the sequence of a maintenance procedure employing the grinding apparatus in accordance with FIG. 2, wherein, during the maintenance procedure, the grinding disc is cleaned and is mostly freed from grinding dust residues.

FIG. 5 is a flow chart illustrating a method for the maintenance/refreshing of grinding discs employing the apparatus in accordance with FIGS. 2-4.

FIG. 6 illustrates a further example of a grinding apparatus which is suitable for robot-supported grinding and which has an integrated maintenance unit for removing worn grinding discs and (optionally) for attaching new grinding discs.

FIG. 7 is an exploded view of the grinding apparatus from FIG. 6.

FIG. 8 illustrates an example of a removal unit 40 of the maintenance unit from FIG. 7.

FIG. 9 illustrates an example of a hopper 50 of the maintenance unit from FIG. 7 which may contain a stack of new grinding discs.

FIG. 10 is a sectional view (longitudinal section) of the hopper from FIG. 9.

FIGS. 11-13 illustrate the sequence of a maintenance procedure with the grinding apparatus in accordance with FIG. 6, wherein, during the maintenance procedure, the worn grinding disc is removed from the grinding machine and a new grinding disc is attached.

FIG. 14 is a flow chart illustrating a method for replacing grinding discs which is carried out with the apparatus in accordance with FIGS. 6-10.

### DETAILED DESCRIPTION

Before various embodiments of the present invention are discussed in detail, first a general example of a robot-supported grinding machine will be described. It is clear that the concepts described here may also be applied to other types of surface machining (e.g. polishing) and are not restricted to grinding procedures. In the following, embodiments will be described with reference to a grinding device with a rotating grinding tool (grinding disc). The concepts described here, however, are not limited to this and may also be employed with other machine tools, for example, those with revolving tools (e.g. belt sanders) or vibrating tools (e.g. orbital sanders).

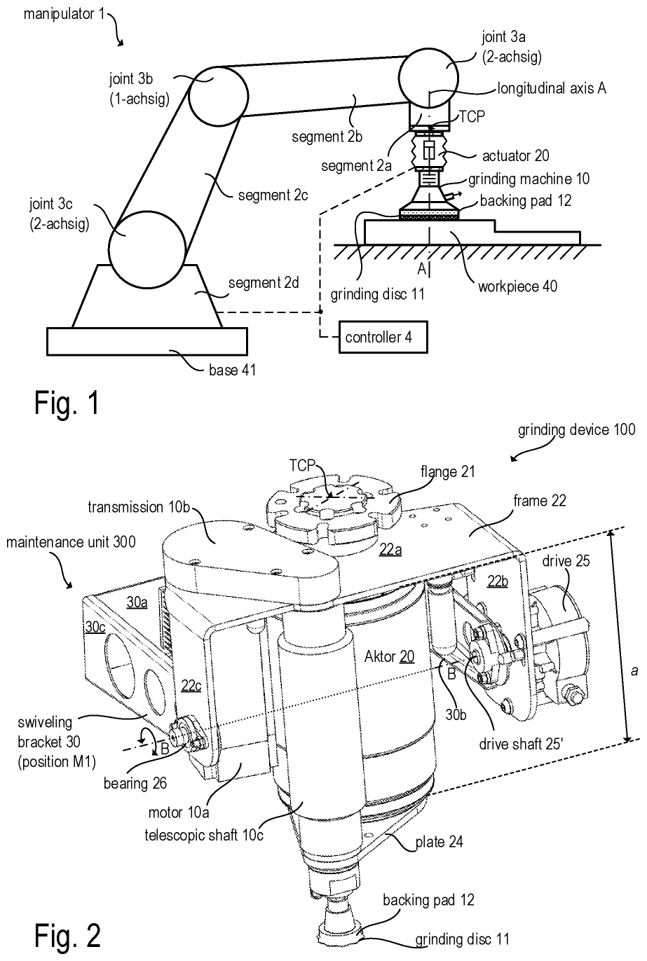

In accordance with FIG. 1 the apparatus comprises a manipulator 1, for example an industrial robot, and a grinding machine 10 with a rotating grinding tool (e.g. an orbital sander), wherein the grinding tool is coupled to the so-called tool center point (TCP) of the manipulator 1 via a linear actuator 20. Strictly speaking, the TCP is actually not a point, but rather a vector and it can be described, for example, with spatial coordinates and three angles. In robotics, the position of the TCP is also sometimes described in a configuration space using generalized coordinates (usually six joint angles of the robot). The position and orientation of the TCP are sometimes also referred to together as “pose”.

In the case of an industrial robot which has six degrees of freedom, the manipulator may be composed of four segments 2a, 2b, 2c and 2d, each of which is connected via the joints 3a, 3b and 3c. Generally the first segment is rigidly attached to a base 41 (which, however, need not necessarily be the case). The joint 3c connects the segments 2c and 2d. The joint 3c may be biaxial and allow for a rotation of the segment 2c around a horizontal axis of rotation (elevation angle) and around a vertical axis of rotation (Azimuth angle).

The joint 3b connects the segments 2b and 2c and allows a for a swivel movement of segment 2b relative to the position of segment 2c. The joint 3a connects the segments 2a and 2b. The joint 3a may be biaxial and can therefore (as in the case of joint 3c), allow for a swivel movement in two directions. The TCP is at a fixed position relative to segment 2a, wherein the latter generally also includes a swivel joint (not shown), which allows for a rotational movement around a longitudinal axis A of the segment 2a (designated in FIG. 1 by a dash-dotted line and corresponding, in the example illustrated here, to the axis of rotation of the grinding tool). An actuator (e.g. an electric motor) is assigned to every joint, which can effect a rotational movement around the respective joint axis. The actuators in the joints are controlled by a robot controller 4 in accordance with a robot program. Various industrial robots/manipulators and their respective controllers are widely known and will therefore not be discussed here further.

The manipulator 1 is generally position-controlled, i.e. the robot controller can determine the pose (position and orientation) of the TCP and can move it along a previously defined trajectory. In FIG. 1 the longitudinal axis of the segment 2a, on which the TCP lies, is designated A. When the actuator 20 comes to rest against an end stop, the pose of the TCP also defines the pose of the grinding machine 10 (and also that of the grinding disc 11). As mentioned above, the actuator 20 serves to adjust the contact force (processing force) between the tool and the work piece 40 to a desired value during the grinding process. Directly controlling the force by means of the manipulator 1 is generally too inexact for grinding applications as, due to the high mass inertia of the segments 2a-c of the manipulator 1, it is virtually impossible to quickly compensate peaks in the force (e.g. such as occurs when the tool is placed on the work piece 40) using conventional manipulators. For this reason, the robot controller 4 is configured to adjust the pose (position and orientation) of the TCP of the manipulator 1, while the force is controlled exclusively by the actuator 20.

As mentioned previously, during the grinding process, the contact force F_{K} between the grinding tool and the work piece 40 can be adjusted with the aid of the (linear) actuator 20 and a force controller (which, for example, may be implemented in the controller 4) such that the contact force F_{K} (in the direction of the longitudinal axis A) between the grinding tool and the work piece 40 corresponds to a desired value. Here the contact force F_{K} is a reaction to the actuator force F_{A} with which the linear actuator 20 presses against the work piece surface. If no contact between the work piece 40 and the tool takes place, the actuator 20, in response to the lack of contact force on the work piece 40, moves to an end stop (not shown as it is integrated in the actuator 20) and presses against it with a defined force. In this situation (no contact) the deflection of the actuator is thus at maximum and the actuator 20 is located in its end position (deflection a_{MAX} of the actuator 20). The defined force with which the actuator 20 presses against the end stop may be very small or even adjusted to zero in order to ensure that the contact with the work piece surface is as soft as possible.

The position control of the manipulator 1 (which may also be implemented in the controller 4) can operate fully independently of the force control of the actuator 20. The actuator 20 is not responsible for positioning the grinding machine 10, but only for adjusting and maintaining the desired contact force F_{K} during the grinding process and for determining when contact between the tool and the work piece has occurred. Contact can be easily determined, e.g. by detecting that the actuator has moved out of its end position (the deflection of the actuator a is smaller than the maximum deflection a_{MAX} at the end stop).

The actuator 20 may be a pneumatic actuator, e.g. a double-acting pneumatic cylinder. However, other pneumatic actuators may also be employed such as, e.g. a bellows cylinder and an air muscle. Direct electric drives (gearless) may also come into consideration as an alternative. It is understood that the effective direction of the actuator 20 and the axis of rotation of the grinding machine 10 need not necessarily be aligned with the longitudinal axis A of the segment 2a of the manipulator. When a pneumatic actuator is employed, the force can be controlled by commonly known means with the aid of a control valve, a control (implemented in the controller 4) and a compressed air tank. Since the inclination toward the perpendicular is relevant for the consideration of the gravitational force (i.e. the weight force of the grinding machine 10), the actuator 20 may have an inclination sensor or it may infer this information from the joint angles of the manipulator. The determined inclination is taken into consideration by the force controller. The specific implementation of the force control is commonly known and, as it is of little relevance for the further explanations, it will not be discussed here in detail.

The grinding machine 10 generally has an electric motor which drives the grinding disc 11. In the case of an orbital grinding machine—as with other types of grinding machines the grinding disc 11 is attached to a carrier plate (backing pad 12), which itself is connected to the motor shaft of the electric motor. Asynchronous motors or synchronous motors may be considered. Synchronous motors have the advantage that the rate of rotation does not change together with the load (rather only the slip angle), whereas in asynchronous machines the rate of rotation falls as the load increases. In this case the load on the motor is essentially proportional to the contact force FK and to the friction between the grinding disc 11 and the surface of the work piece 40 intended for machining.

As an alternative to grinding machines with an electric drive, grinding machines with a pneumatic motor (compressed air motor) may also be employed. Grinding machines which are driven by compressed air can be installed relatively compactly as, in general, compressed air motors have a lower power-to-rate ratio. The rotation rate can be easily regulated by means of a pressure control valve (controlled, for example, by the controller 4). In addition to this or as an alternative, a throttle may also be employed for this, whereas frequency converters (controlled, for example, by the controller 4) are needed to regulate the rate of rotation in synchronous and asynchronous motors. The concepts described here can be implemented with numerous different grinding machines, polishing machines and other surface-processing machines.

FIG. 2 illustrates an example of a grinding device 100 which is suitable for robot-supported grinding. A polishing machine may be constructed in a more or less similar manner. When in operation, the grinding apparatus 100 is connected to the TCP of a manipulator (cf. FIG. 1) and is also moved by the latter. In the example illustrated here the grinding apparatus comprises a frame 22, which may be implemented approximately in the shape of a C (C-frame). The center part 22a of the frame 22 has a flange 21 on its top side which is configured to attach the grinding apparatus to the manipulator (e.g. by means of flange-mounting). A first end part of the actuator 20 is mounted on the underside of the center part 22a between the two lateral sections 22b, 22c of the frame 22 (e.g. by means of screws, not shown in FIG. 2). A second end part of the actuator 20 is mounted on the plate 24 (e.g. also by means of screws, not shown in FIG. 2). The deflection of the actuator 20 defines the distance a between the central section 22a of the frame 22 and the plate 24.

The grinding machine, with a grinding disc 11 disposed on a backing pad 12, is mechanically mounted on the plate 24. Consequently, the position of the grinding disc 11 can be determined by the deflection of the actuator 20. In the example illustrated here, not the entire grinding machine is mounted on the plate 24. In order to decouple the comparatively heavy electric motor 10a of the grinding machine (and the mass inertia that it causes) from the backing pad 12, in the present example the electric motor 10a that drives the backing pad 12 is mounted on the frame 22 (e.g. on the branch 22c of the frame 22), wherein the drive torque of the electric motor 10a is transmitted to the backing pad 12 via a transmission 10b (e.g. a belt drive or toothed gearing) and a telescopic shaft 10c. The transmission 10b is also disposed on the frame 22 (e.g. on the upper part 22a) and the telescopic shaft 10c is configured to compensate changes in the distance a between the frame 22 and the plate 24. Thus the length of the telescopic shaft 10c changes in correspondence with the deflection of the actuator 20. The motor 10a, transmission 10b, telescopic shaft 10c and the backing pad 12 with the grinding disc 11 all together form the grinding machine.

An example of a grinding apparatus 100 in which the electric motor and the grinding tool are mechanically decoupled by means of a telescopic shaft is known from the publication EP 3 325 214 B1, the contents of which are taken into account in their entirety with this reference. It should be mentioned, however, that the integrated maintenance unit of the grinding apparatus 100 discussed in the following may also be used with grinding machines of simpler construction, in which case the entire grinding machine (including the motor) is disposed on the plate 24 and, consequently, no decoupling of the electric motor's mass is needed.

In accordance with the concepts described here, the maintenance unit 300 integrated in the grinding apparatus 100 is swivel-mounted on the frame 22 around an axis of rotation B. In the example illustrated in FIG. 2, the maintenance unit 300 comprises a bracket 30 which is mounted on the frame 22, may be implemented, e.g. in the shape of an L or a C (central section 30a, branches 30b and 30c) and which carries some of the components of the maintenance unit. The swivel movement of the bracket 30 can be effected, for example, by the drive 25. The drive 25 may be, for example, a direct electric drive (electric motor). However, other types of drives such as, e.g. pneumatic drives, may also be employed. Drives with transmissions (e.g. belt drives) may also be used.

The drive 25 in the example illustrated in FIG. 2 is thus mounted on the branch 22b of the frame 22 so that the drive shaft 25′ of the drive 25 (the axis of which determines the axis of rotation B) lies essentially perpendicular to the effective direction of the actuator 20. A branch 30b of the swiveling bracket 30 may be rigidly connected to the drive shaft 25′ (e.g. clamped). Alternatively it would also be possible to mount the drive 25 on the branch 30b of bracket 30 and to connect the drive shaft 25′ to the branch 22b of the frame. In order to ensure a stable mounting of the swiveling bracket 30 on the frame 22, the other branch 30c of the bracket 30 is mounted on the corresponding branch 22c of the frame by means of a bearing (e.g. a ball bearing).

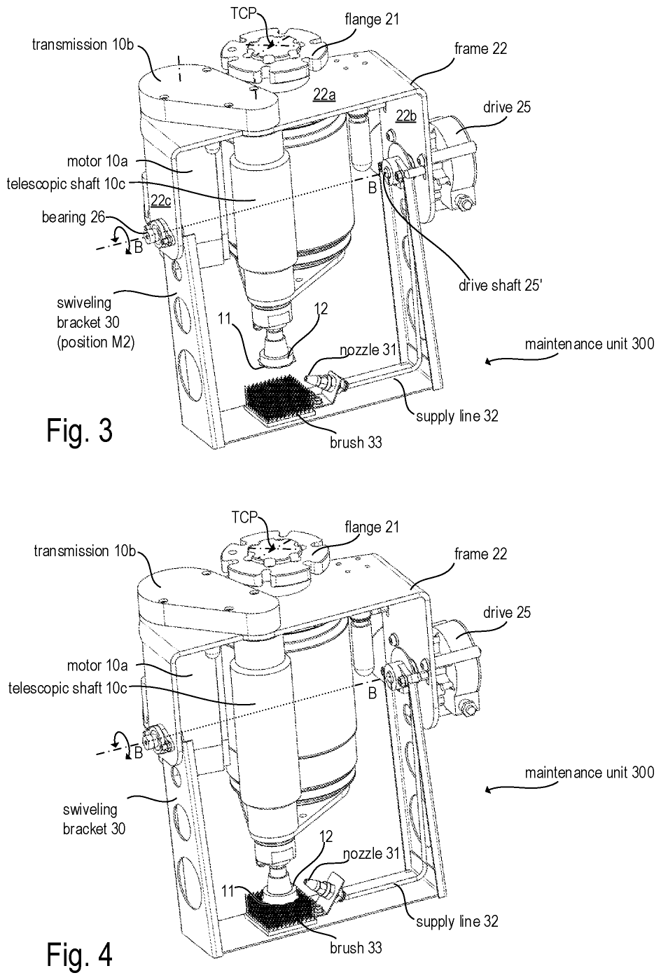

FIG. 2 shows the grinding apparatus 100 with a folded-up (inactive) maintenance unit 300. In this situation the swiveling bracket 30 is tilted so far that the center part 30a is essentially located next to the grinding machine and does not impede the grinding process (inactive state—standby mode—of the grinding device). FIG. 3 shows the grinding apparatus 100 with an unfolded (active) maintenance unit 300, wherein the central section 30a of the swiveling bracket 30 is positioned before the backing pad 12 (grinding device is in maintenance mode). A brush 33 is disposed on the central section 30a of the bracket 30 which directly faces the grinding disc 11 when the maintenance unit is active (i.e. in maintenance mode). Further, a nozzle 31 is disposed on the bracket 30 which directed at the grinding disc 11 and which is configured to spray a cleaning agent (e.g. water) onto the grinding disc 11 while the disc is still attached to the backing pad 12. The actuator 20 can be controlled to press the backing pad 12, and thereby also the grinding disc 11, against the brush 33 either before or after the grinding disc 11 is sprayed with water (or with a different cleaning agent). While the grinding disc 11 is being pressed against the brush 33, the grinding disc 11 can rotate in order to obtain even better cleaning results. Most of the grinding dust adhered to the grinding disc 11 is removed in the process. The steps of spraying the grinding disc 11 with water and of pressing the rotating grinding disc 11 against the brush 33 may be repeated as often as needed. Afterwards the bracket 30 may once again be folded up and the grinding process may be continued with a “refreshed” grinding disc 11. FIG. 4 shows the actuator 20 pressing the grinding disc 11 against the brush 33 when the maintenance unit 300 of the grinding apparatus 100 is active.

The supply line 32 (for example, a hose) through which the nozzle 31 is supplied with the cleaning agent can follow along the bracket 32 to the frame 22. A connection for the supply line can be provided on the frame 22. Here it should be mentioned that the hose 32 is not capable of exerting any force on the actuator 20 that could have any effect on the backing pad 12. All bearing forces are absorbed by the frame 22 and, consequently, by the (position-controlled) manipulator 1.

In addition or as an alternative to spraying the grinding disc with a cleaning agent, the grinding disc can be blown clean with compressed air. Accordingly, in one embodiment compressed air is channeled through the nozzle 31. In another embodiment numerous nozzles (and their respective supply lines) are arranged on the bracket 30, making it possible to treat the grinding disc both with a cleaning agent (e.g. water), as well as with compressed air. The nozzles can be arranged directly next to each other.

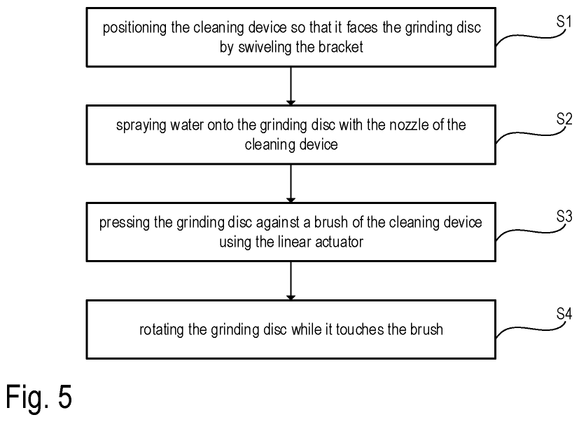

FIG. 5 is a flow chart illustrating a method that can be carried out using the maintenance unit 300 integrated in the grinding apparatus and illustrated in FIGS. 2-4. In order to refresh, when needed, the grinding disc 11, first of all, the robot program currently being executed is interrupted and the maintenance unit 300 is activated by positioning the swiveling bracket 30 such, with respect to the grinding disc 11, that the cleaning device (i.e. the brush 33) faces the grinding disc 11 (FIG. 5, Step S1). Following this, water or a different cleaning agent can be sprayed onto the grinding disc 11 with the nozzle (FIG. 5, Step S2). This will already serve to remove some of the particles adhered to the grinding disc. After that the actuator 20 is controlled to press the grinding disc against the brush 33 (FIG. 5, Step S3). The force with which the grinding disc 11 is pressed against the brush 33, (just as with the machining force during grinding), can be regulated. In the embodiment illustrated here the motor of the grinding machine is activated in order to rotate the grinding disc 11 while it is being pressed against the brush (FIG. 5, Step S4). At the same time, the force with which the grinding disc 11 is pressed against the brush 33 can also be varied.

The steps S2, S3 and S4 need not necessarily be conducted in the aforementioned sequence. Each of the individual steps can also be carried out several times. Thus, for example, the steps S3 and S4 (pressing the grinding disc against the brush and rotating the grinding disc) can be carried out before Step S2 (spraying the grinding disc with water) and can be carried out again afterwards. In a further embodiment, the grinding disc can be rotated while being sprayed with water (Step S2). With the additional aid of a controller (cf. e.g. FIG. 1, Controller 4), a wide range of various maintenance and cleaning operations can be carried out. Upon concluding the process, the maintenance unit 300 can once again be deactivated by folding up the swiveling bracket 30, thereby returning it to its position next to the grinding machine, and the grinding process can be continued as needed.

As mentioned earlier, the tool need not necessarily rotate. In some embodiments revolving tools may be used, for example a grinding belt, as in the case of a belt grinding machine. Furthermore, the grinding or polishing disc may carry out an oscillating movement (vibration), as in the case, for example, of vibration sanders. Obviously, in embodiments such as these the tool is not rotated while being pressed against the brush, but is instead driven in accordance with the respective functioning of the machine tool.

For use, in particular, with polishing machines, in addition to the supply line 32 for the cleaning agent, a further supply line can be provided to convey a fluid or paste such as, for example, a polishing agent, which can then be applied to the polishing disc through an additional nozzle. The supply line and nozzle for the polishing agent can essentially be constructed in the same manner as the supply line 32 and the nozzle 31 in FIG. 3. In still a further embodiment, the maintenance unit comprises neither a brush 33 nor a supply line with nozzle for a cleaning agent, but rather only a supply line with a nozzle for a polishing agent. In this case the maintenance unit only serves the purpose of applying polishing agent to the polishing tool. The reference numeral “11” refers in this case not to a grinding disc, but rather to a polishing disc.

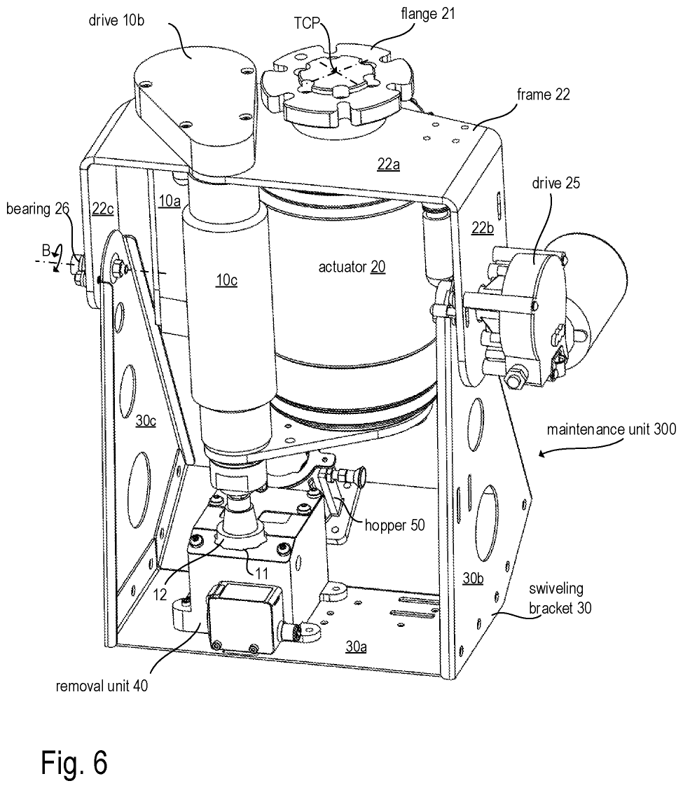

FIG. 6 illustrates a further example of a grinding apparatus 100 with an integrated maintenance unit 300 and which can be used in robot-supported grinding. As opposed to the previous example from FIG. 2, in the present example the maintenance unit 300 is configured to remove worn grinding discs from the backing pad 12 of the grinding machine and (optionally), to take new grinding discs out of a hopper and attach them onto the backing pad 12. The entire process of changing the grinding disc can be carried out fully automatically, and it is not necessary for the robot 1 to move into a specific maintenance position in order to do so.

With the exception of the maintenance unit 300, the apparatus from FIG. 6 is essentially the same as the apparatus from FIG. 2 and reference is therefore made to the descriptions regarding FIGS. 2-4. In the following, only the maintenance unit 300 will be discussed which, as in the preceding example, is swivel-mounted on the frame 22 such that it can be positioned, at least partially, before the tool (i.e. before the backing pad 12 with the grinding disc 11).

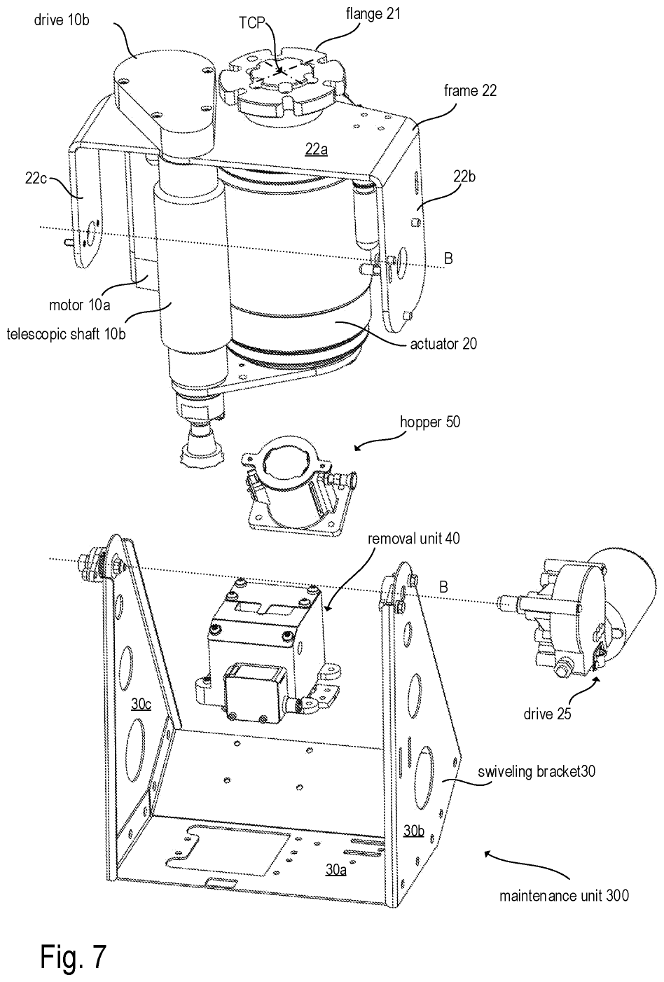

In accordance with FIG. 6, the maintenance unit 300 comprises a swiveling bracket 30, which is mounted on the frame 22. In addition to this, the branches 30b and 30c of the bracket 30 are mounted on the corresponding lateral sections 22b and 22c of the frame 22 (cf. FIG. 2, Bearing 26). A removal unit 40 and/or a hopper 50 with new grinding discs (e.g. daisy discs) is(are) is mounted on the central section 30a of the bracket 30. The removal unit 40 enables the fully automated removal of a worn grinding disc, without the need for the robot 1 to move into a specific maintenance position. The removal of a grinding disc can be carried out at any conceivable pose of the robot, as long as the swiveling of the maintenance unit does not cause an unwanted collision. The swivel movement of the bracket 30 of the maintenance unit 300 around the axis of rotation B (as in the example from FIG. 2) can be carried out with the aid of the drive 25, allowing for an exact positioning of the removal unit 40 and the hopper 50 relative to the tool (backing plate 12 with grinding disc 11). FIG. 7 is an exploded view of the apparatus from FIG. 6. Here the individual components of the maintenance unit are more easily recognizable.

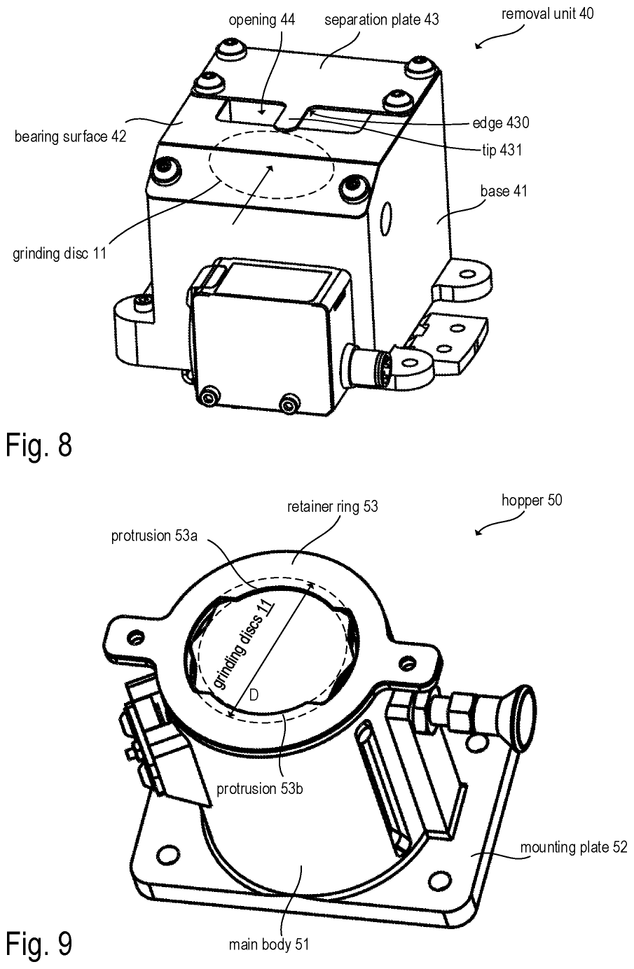

FIG. 8 illustrates the removal unit 40 in greater detail. It includes a base frame 41 which is mounted on the central section of the bracket 30 and which can be positioned before the backing pad 12 by swiveling the bracket 30. A bearing surface 42 is disposed on the top side of the base frame. Further, a separation plate 43 is mounted on the bearing surface 42, the edge 430 of which may comprise a central tip 431. Alternatively, the edge 430 may also be straight. The separation plate 43 lies essentially parallel to the bearing surface 42 and is at a distance to the latter that essentially corresponds to the thickness of a grinding disc 11.

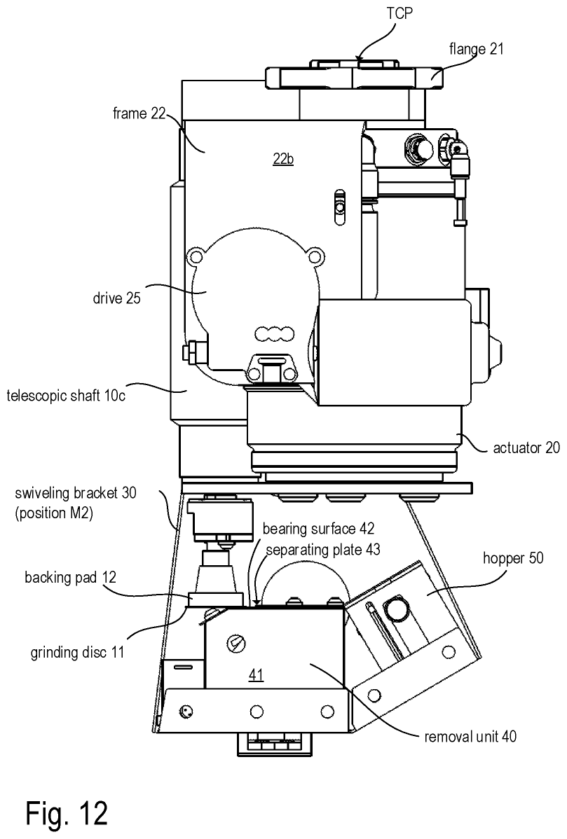

In a removal procedure, a grinding disc 11 attached to the backing pad 12 is pressed by the actuator 20 against the bearing surface 42. The removal unit 40 is brought into a position (by swiveling the bracket 30) in which the grinding disc 11 rests on the bearing surface 42 before the edge 430 of the separation plate 43 (see FIG. 8, the dashed line symbolizes the grinding disc 11). Following this the drive 25 moves the bracket 30 together with the removal unit 40 towards the grinding disc 11 until the edge 430 and, in particular, the tip 431 (if provided) is pushed in between the backing pad 12 and the grinding disc 11, thereby detaching the grinding disc 11 from the backing pad 12 (see also FIG. 12). Once the edge 430 of the separation plate 43 has been moved across the entire backing pad 12 (as a result of the swivel movement of the maintenance unit 300), the grinding disc 11 will be completely detached and can fall through the opening 44 in the base frame 41. It is also possible to dispose of the detached grinding disc 11 by means of compressed air or suction. A stationary (provided at a permanent location within the robot cell) removal unit that employs a similar approach as that of the removal unit 40 from FIG. 8 is known from the publication US 2019/0152015 A1, the contents of which are taken into account in this description in their entirety with this reference. As opposed to the system known from this publication, in the embodiments in accordance with FIGS. 6-13 the movement needed for the removal procedure is not carried out by the robot 1, but rather by the drive 25, which is capable of swiveling the bracket 30. More details regarding the removal procedure are provided further below with reference to FIG. 12.

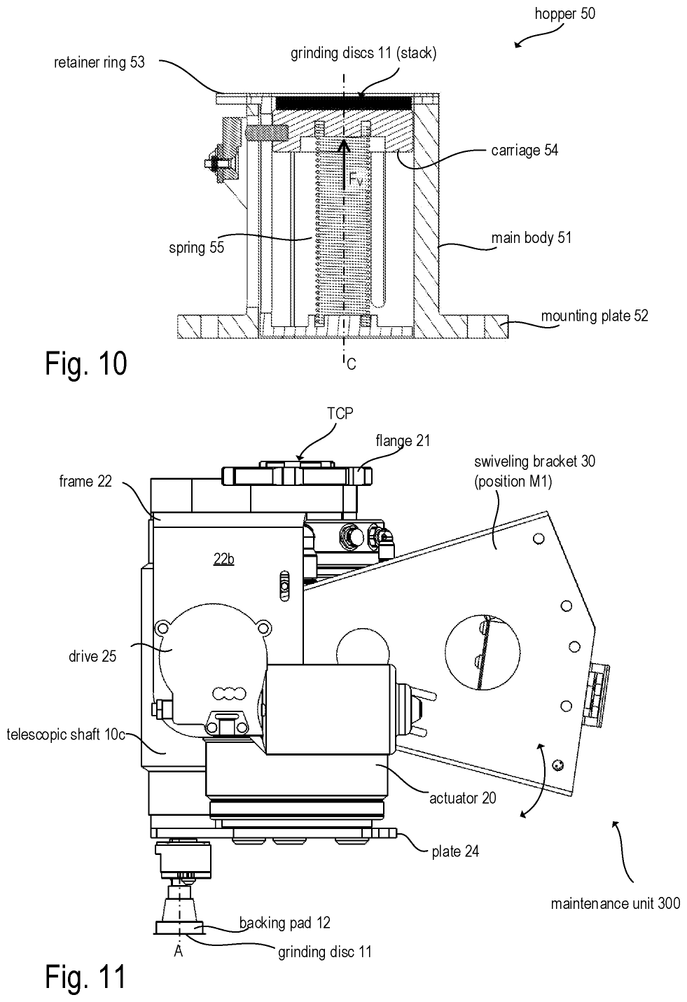

FIGS. 9 and 10 illustrate the hopper 50 in greater detail, whereas FIG. 10 is a sectional view (longitudinal section) corresponding to FIG. 9. In accordance herewith, the hopper 50 comprises a main body 51 with a mounting plate 52 which may be mounted on the central section 30a of the bracket 30 behind the removal unit 40. The main body 51 is hollow on the inside and a carriage 54 is slidably mounted on the inside of the main body 51. When the hopper 50 is positioned before the backing pad 12 of the grinding machine, the longitudinal axis C, along which the carriage 54 can be slid, lies approximately coaxially to the axis of rotation of the backing pad 12. A stack of new grinding discs can be placed on the top side of the carriage 54 and a spring 55 is disposed on the inside of the main body 51 such that a biasing force FV is exerted onto the carriage 54, pushing it in the direction of the top side of the main body 51. As a result of the biasing force FV, the stack of grinding discs 11 arranged on the carriage 54 becomes clamped in between the carriage 54 and a retainer ring 53 disposed on the top side of the main body 51.

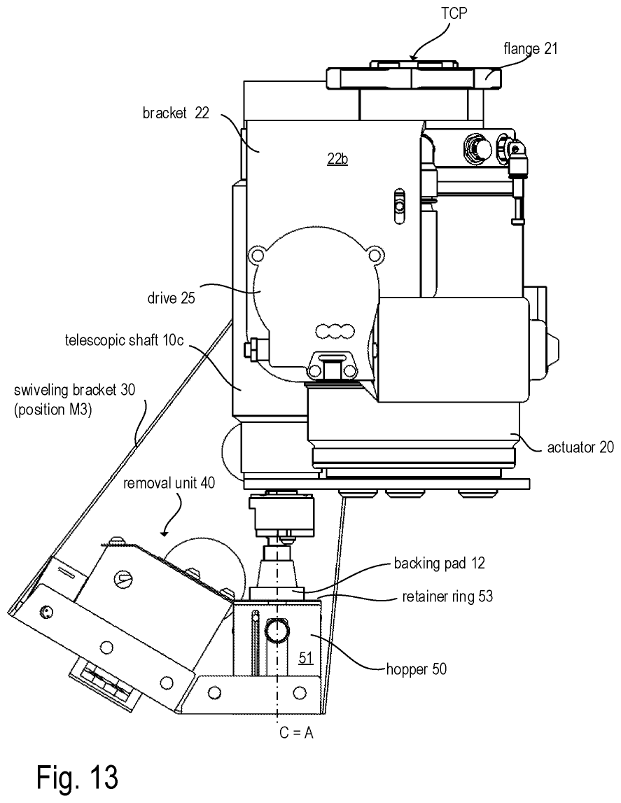

As viewed from above (as shown, for example, in FIG. 9), the topmost grinding disc of the stack of grinding discs is pressed from below against the retainer ring 53, which may be attached to the main body 51, e.g. by means of screws. The retainer ring may have an inner diameter D that is somewhat larger than the maximum diameter of the grinding discs. In this case the grinding discs 11 are only retained by the inwardly projecting protrusions 53a and 53b. In the example from FIG. 9 the retainer ring 53 comprises two protrusions 53a, 53b, which extend along a section of the inner periphery of the retainer ring 53, locally reducing the inner diameter. In other examples the retainer ring comprises more than two protrusions. In general the protrusions serve to retain the grinding discs only by a small surface on the edge of the grinding discs. Because of the grinding discs flexibility (which are made, e.g. of paper, as in the case, e.g. of daisy discs), the topmost grinding disc can easily be taken out of the hopper if it adheres to the backing plate 12 of the grinding machine (e.g. by means of a Hook and loop fastener or adhesive). The loading process, in which a new grinding disc is mounted onto the backing pad 12 of the grinding machine, will be discussed in greater detail further on with reference to FIG. 13.

FIGS. 11-13 illustrate the sequence of a maintenance procedure employing the grinding apparatus in accordance with FIG. 6, wherein, in the maintenance procedure, the worn grinding disc is removed from the grinding machine and a new grinding disc is attached. In the situation illustrated in FIG. 11, the swiveling bracket 30 of the maintenance unit 300 is in a folded-up position, which is designated here as “Position M1” (this situation essentially corresponds to the one illustrated in FIG. 2). In the position M1 the central section 30a of the swiveling bracket 30 of the maintenance unit 300 is positioned essentially next to the grinding machine (i.e. next to the axis of rotation of the backing pad 12). This means that the maintenance unit 300 is positioned so as not to impede a grinding process. The robot 1 can bring the grinding disc 11 into contact with the surface of a work piece and can machine the surface.

By swiveling the bracket 30 the maintenance unit 300 can be positioned at least partially before the tool, i.e. before the grinding disc 11 attached to the backing pad 12, in order to begin a maintenance procedure. In the situation illustrated in FIG. 12 the bracket 30 is in the position designated as “Position M2”, in which the removal unit 40 is disposed opposite the grinding disc 11. With the aid of the actuator 20, the grinding disc 11 can be pressed against the bearing surface 42 on the top side of the removal unit 40 (cf. also FIG. 8).

Starting from the position M2, the bracket 30 is swiveled further to the left while the grinding disc is pressed against the bearing surface 42 (the direction “to the left”, as well as designations such as “upwards” or “downwards” naturally only refer to the specific illustrations). By means of this further swivel movement of the bracket 30, the separation plate 43 is pushed, as described above, in between the backing pad 12 and the grinding disc 11, whereby the grinding disc 11 is detached from the backing pad 12. The detached grinding disc 11 can fall through the opening 44 in the removal unit 40 (not visible in FIG. 12, see FIG. 8) and can land, for example, in a small receptacle. Alternatively, the grinding disc may fall out of the maintenance unit or be disposed of by means of compressed air.

A further swivel movement of the bracket 30 positions the maintenance unit 300 into the position designated as “Position M3” in which the hopper 50 (now unloaded) lies opposite the backing pad 12. As mentioned, the axis of rotation A of the backing pad 12 and the longitudinal axis C of the hopper 50 (see FIG. 10) are arranged essentially coaxially. With the aid of the actuator 20, the backing pad 12 is pressed against the top side of the hopper 50 and thus also against the backside of the topmost grinding disc in the stack of grinding discs contained in the hopper. The backside of the topmost grinding disc in the hopper 50 adheres to the backing pad 12, for example, because the backside of the grinding disc 11 and the surface of the backing pad 12 are designed to form a hook and loop fastener. Alternatively, the backside of the grinding disc can be designed to adhere to the surface of the backing pad 12. In this case, for example, the backside of the grinding disc may be provided with an adhesive layer. With the aid of the actuator 20, the backing pad 12 is again lifted up, whereby, due to the adhesion between the new grinding disc and the backing pad 12, the grinding disc is taken out of the hopper. After this, the maintenance unit may be once again folded up into the position M1 and the grinding process may be continued with the new grinding disc.

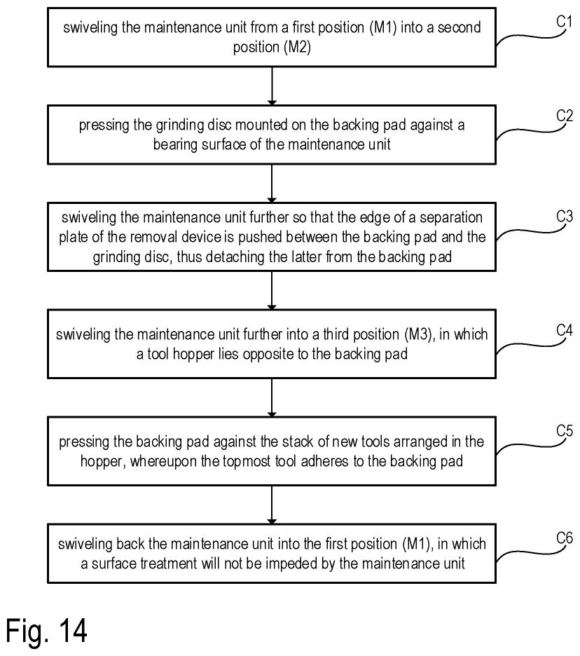

The process involving the automated replacement of a grinding disc of a robot-supported grinding machine that is illustrated with reference to FIGS. 11 to 13 is once again summed up with reference to the flow chart in FIG. 14. In accordance with FIG. 14, the maintenance unit 300 is positioned before the grinding disc 11 which is attached to the backing pad of the grinding machine. This is accomplished by swiveling the maintenance unit from a first position (cf. FIG. 11, Position M1) into a second position (cf. FIG. 12, Position M2 and FIG. 14, Step C1). After this the grinding disc 11 attached to the backing pad 12 is pressed against the bearing surface 42 of the removal unit 40 of the maintenance unit 300 (see FIG. 14, Step C1 and FIG. 12). In order to detach the grinding disc 11 from the backing pad 12, the maintenance unit 300 is swiveled further. This pushes the edge 430 of the separation plate 43 of the removal unit 40 in between the backing pad 12 and the grinding disc 11, detaching the latter from the backing pad 12 (see FIG. 14, Step C3). In this regard reference is also made to the description of FIG. 8.

In order to attach a new grinding disc onto the backing pad 12, the maintenance unit is further swiveled into the third position M3 (cf. FIG. 13, Position M3) in which the hopper 50 lies opposite the backing pad 12 (see FIG. 14, C4). A stack of new grinding discs 11 is arranged in the hopper 50. By pressing (see FIG. 15, Step C5) the backing pad 12 against the stack of new grinding discs arranged in the hopper 50, the topmost tool of the stack adheres (e.g. by means of a hook and loop fastener) to the backing pad 12. After this the maintenance unit 300 can be swiveled back into the first position M1 (see FIG. 15, Step C6) in which a surface machining with the grinding disc 11 will not be impeded by the maintenance unit.

The embodiments described here may be combined. Thus, for example, it is possible to additionally provide a cleaning apparatus in the example from FIG. 6. This could be arranged, for example, next to the hopper, making it possible to carry out a cleaning when the maintenance unit is swiveled into a fourth position (M4, not illustrated). Every device or subunit of the maintenance unit 300 can be assigned to a specific position (e.g. M2, M3, etc.) in which the respective device or subunit lies opposite the backing pad 12 in order to carry out, from this position, a maintenance procedure. Thus the robot is capable of carrying out various maintenance procedures from virtually any position.

1. An apparatus comprising the following:
a frame (22) which can be mounted on a manipulator (2);
a machining device with a tool (11);
a linear actuator (20) coupled to the machining device for adjusting a relative position of the tool (11) in relation to the frame (22);
a maintenance unit (300) with a bracket (30) which is swivel-mounted on the frame (22) such that the maintenance unit (300) can be positioned at least partially before the tool (11) by swiveling the bracket (30).

2. The apparatus in accordance with claim 1,
wherein the maintenance unit (300) comprises a cleaning device (33, 31) which can be positioned opposite the tool (11) by swiveling the bracket (30).

3. The apparatus in accordance with claim 2,
wherein the cleaning device comprises a brush (33) which can be positioned by swiveling the bracket (30) such that the tool (11) can be pressed against the brush (33) with the aid of the linear actuator (20).

4. The apparatus in accordance with claim 2 or 3,
wherein the cleaning device comprises at least one nozzle (31) which can be positioned by swiveling the bracket (30) such that a cleaning agent can be sprayed, or compressed air can be blown, through the nozzle (31) onto the tool (11).

5. The apparatus in accordance with any of claims 1 to 4,
wherein the linear actuator (20) is configured to press the tool (11) against a section of the maintenance unit (300) when in a maintenance mode.

6. The apparatus in accordance with any of claims 1 to 5,
wherein the maintenance unit (300) comprises a removal unit (40) which is configured to remove the tool (11) from the machining device.

7. The apparatus in accordance with claim 6,
wherein the machining device is a grinding machine and the tool (11) is a grinding disc.

8. The apparatus in accordance with claim 6 or 7,
wherein the removal unit (40) comprises a bearing surface (42) and a separation plate (43) which is arranged essentially parallel to the separation plate (42) such that, when the tool (11) is pressed against the bearing surface (42), through a movement of the removal unit (40) which is effected by swiveling the bracket (30), the separation plate (43) is inserted in between the tool (11) and a backing pad (12) on which the tool is attached, whereby the tool (11) is detached from the backing plate (12).

9. The apparatus in accordance with any of claims 1 to 8,
wherein the maintenance unit (300) further comprises a hopper (50) which can accommodate numerous tools of the same type, in particular grinding discs.

10. The apparatus in accordance with claim 9,
wherein the hopper (50) comprises a main body (51), on the inside of which a carriage (54) biased with a spring (55) is disposed and a retainer ring (53), wherein, when a stack of tools (11) is arranged on the carriage (54), the force (Fv) produced by the spring (55) presses the tool (11) against the retainer ring (53).

11. The apparatus in accordance with any of claims 1 to 10,
wherein the maintenance unit (300) comprises a second nozzle which can be positioned by swiveling the bracket (30) such that a liquid or a paste, in particular a polishing agent, can be applied onto the tool through the second nozzle.

12. The apparatus in accordance with any of claims 1 to 11, further comprising:
a drive (25) which is coupled to the frame (22) and to the bracket (30) and which is configured to swivel the maintenance unit (300) from a first position (M1) into a second position (M2).

13. The apparatus in accordance with claim 12,
wherein the maintenance unit (300) in the second position (M2) is positioned at least partially before the tool (11) and in the first position (M1) does not impede a machining of the work piece surface with the tool (11).

14. The apparatus in accordance with any of claims 1 to 13,
wherein the machining device comprises a motor (10a) which is mounted on the frame (22), as well as a telescopic shaft (10c) which couples the motor (10a) to the tool (11).

15. A method comprising the following:
positioning a maintenance unit (300), which is swivel-mounted on a frame (22), into a position in which the maintenance unit (300) is positioned before a tool (11) of a machining device, wherein the tool (11) is coupled to the frame (22) via a linear actuator (20) and wherein the frame (22) is mounted on a manipulator (1);
pressing the tool (11) with a pressing force against a component of the maintenance unit (300) with the aid of the linear actuator (20).

16. The method in accordance with claim 15,
wherein the component of the maintenance unit (300) is a brush (33) of a cleaning device.

17. The method in accordance with claim 16, further comprising:
spraying a cleaning agent onto the tool (11) by means of a nozzle (31) of the cleaning device and/or blowing the tool with compressed air.

18. The method in accordance with any of claims 15 to 17,
wherein the tool (11) is driven by a motor of the machine tool while being pressed against the component of the maintenance unit (300).

19. The method in accordance with any of claims 15 to 18,
wherein the machining device is a grinding machine and the tool (11) is a grinding disc disposed on a rotating backing pad (12) of the grinding machine.

20. The method in accordance with any of claims 15 to 18,
wherein the machining device is a belt sander and the tool (11) is a revolving sanding belt.

21. The method in accordance with any of claims 15 to 18,
wherein the machining device is a vibration sander and the tool (11) is a grinding disc which is disposed on an oscillating backing pad (12) of the grinding maching.

22. The method in accordance with any of claims 15 to 18,
wherein the machining device is a polishing machine and the tool (11) is a polishing disc attached to a backing pad (12).

23. The method in accordance with claim 15,
wherein the component of the maintenance unit (300) is a bearing surface (42) of a removal unit (40).

24. The method in accordance with claim 23, further comprising:
swiveling the maintenance unit (300) until an edge (430) of a separation plate (43) of the removal unit (40) is inserted in between a backing pad (12) and the tool (11) attached to it, thereby detaching the tool (11) from the backing pad (12).

25. The method in accordance with claim 23,
wherein a further component of the maintenance unit (300) is a hopper (50) with a stack of new tools contained therein and wherein the method further comprises:
swiveling the maintenance unit (300) until the hopper (50) lies opposite a backing pad (12) of the machining device;
pressing the backing pad (12) against the stack of tools contained in the hopper (50), wherein the topmost tool of the stack adheres to the backing pad (12).

26. A method for the automatic replacement of grinding discs of a grinding machine, the method comprising:
positioning, by means of swiveling a maintenance unit (330), a maintenance unit (300), which can be swiveled relative to the grinding machine, from a first position (M1) into a second position (M2), in which the maintenance unit (300) is positioned before a grinding disc (11) attached to a backing pad (12) of the grinding machine;
pressing the grinding disc (11) attached to the backing pad (12) against a bearing surface (42) of a removal unit (40) of the maintenance unit (300);
swiveling the maintenance unit (300) further until an edge (430) of a separation plate (43) of the removal unit (40) is inserted in between the backing pad (12) and the grinding disc (11), thereby detaching the latter from the backing pad (12).

27. The method in accordance with claim 26, further comprising:
swiveling the maintenance unit (300) further into a third position (M3) in which a hopper (50) lies opposite the backing pad (12), wherein a stack of new grinding discs (11) is disposed in the hopper (50);
pushing the backing pad (12) onto the stack of new tools contained in the hopper (50), whereby the topmost tool of the stack adheres to the backing pad (12).

28. The method in accordance with claim 27, further comprising:
swiveling the maintenance unit (300) into the first position (M1) in which a surface machining with the grinding disc (11) of the maintenance unit is not impeded by the maintenance unit (300).

29. The method in accordance with claim 28,
wherein, in the first position (M1), the maintenance unit is essentially next to the grinding machine.

30. A method comprising:
positioning a maintenance unit (300), which can be swiveled relative to a polishing machine and which has a nozzle, into a maintenance position (M2) in which the nozzle is directed at a polishing tool of the polishing machine;
applying a polishing agent to the polishing tool by spraying the polishing agent onto the polishing tool with the aid of the nozzle;
positioning the maintenance unit (300) in a folded-up position (M2), in which a polishing process is not impeded.

31. The method in accordance with claim 30, wherein the polishing machine is guided by a robot and the positioning is effected by the controller of the robot.
